(19) United States
(12) Patent Application Publication
(10) Pub. No.: US 2012/0317018 A1
(43) Pub. Date: Dec. 13, 2012

(54) SYSTEMS AND METHODS FOR PROTECTING ACCOUNT IDENTIFIERS IN FINANCIAL TRANSACTIONS

(76) Inventor: Timothy W. Barnett, Roswell, GA (US)

(21) Appl. No.: 13/157,050

(22) Filed: Jun. 9, 2011

(51) Int. Cl. G06Q 40/00

(52) U.S. Cl. 705/39

(57) ABSTRACT

In a system for protecting account identifiers in financial transactions, a consumer provides an account identifier to be used for purchasing a good or service from a merchant. However, only a portion of the account identifier is transmitted to the merchant. The remaining portion of the account identifier is transmitted to a server, referred to as a “payment facilitator,” that is not controlled by the merchant. During the financial transaction, the merchant submits a request for financial payment containing a portion of the consumer's account identifier to the payment facilitator. The payment facilitator combines the account identifier portion in the request with the account identifier portion transmitted to it from the consumer in order to determine the consumer's full account identifier. The payment facilitator then submits a request for financial payment to a financial institution for approval.

### RELATED ART

Financial transactions, such as credit or debit card transactions, typically involve the use of an account identifier identifying a financial account to be debited or charged for a purchase. In such a financial transaction, a consumer provides an account identifier to a merchant, which uses the account identifier to request payment from a financial institution. If the financial institution approves the request, funds are charged or debited from the identified account, and at least a portion of such funds are transferred to an account of the merchant.

In some cases, a personal identification number (PIN) is used to authenticate the consumer who provides the account identifier in order to deter and prevent fraudulent use of the consumer's account. However, the use of a PIN can be burdensome to a consumer who is required to memorize the PIN and provide the PIN during the transaction. Further, the manner in which PINs can be handled by a merchant or other entity is regulated, adding to the complexity of the financial transaction. Moreover, there are several types of financial transactions, such as credit card transactions and some debit transactions, that do not utilize a PIN and/or authenticate the consumer. Such financial transactions are particularly vulnerable to fraudulent uses of the consumer's account identifier.

In this regard, despite security measures for protecting account identifiers, a hacker or other unauthorized user can gain access to a consumer's account identifier as it is being transmitted during the financial transaction. In addition, account identifiers can be captured by key logging, which is a process by which malicious software captures a user's keystrokes in an effort to discover sensitive information. Also, unscrupulous employees of the merchant may misuse an account identifier that has been transmitted to the merchant. Further, merchants often store account identifiers in databases that are susceptible to hacking and other intrusions. Such threats are well-known and result in the loss of millions of dollars annually to the financial industry. Despite such losses, many financial institutions issue accounts without attempting to protect the accounts through PINs and other security measures that are burdensome to consumers.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a financial payment system.

FIG. 2 is a block diagram illustrating an exemplary embodiment of a consumer computing apparatus, such as is depicted by FIG. 1.

FIG. 3 is a block diagram illustrating an exemplary embodiment of a payment facilitator, such as is depicted by FIG. 1.

FIG. 4 is a diagram illustrating an exemplary embodiment of graphical user interface (GUI) for soliciting account information from a consumer.

FIG. 5 is a diagram illustrating an exemplary embodiment of a GUI for soliciting at least a portion of an account identifier from a consumer.

FIG. 6 is a flow chart illustrating an exemplary method implemented by a consumer computing apparatus, such as is depicted by FIG. 1.

FIG. 7 is a flow chart illustrating an exemplary method implemented by a merchant computing apparatus, such as is depicted by FIG. 1.

FIG. 8 is a flow chart illustrating an exemplary method implemented by a payment facilitator, such as is depicted by FIG. 1.

FIG. 9 is a block diagram illustrating an exemplary embodiment of a financial payment system.

### DETAILED DESCRIPTION

The present disclosure generally pertains to systems and methods for protecting account identifiers in financial transactions. In one exemplary embodiment, a consumer provides an account identifier to be used for purchasing a good or service from a merchant. However, only a portion of the account identifier is transmitted to the merchant. The remaining portion of the account identifier is transmitted to a server, referred to as a “payment facilitator,” that is not controlled by the merchant. During the financial transaction, the merchant submits a request for financial payment containing a portion of the consumer's account identifier to the payment facilitator. The payment facilitator combines the account identifier portion in the request with the account identifier portion transmitted to it from the consumer in order to determine the consumer's full account identifier. The payment facilitator then submits a request for financial payment to a financial institution for approval, and the payment facilitator receives from the financial institution an indication whether the request is approved. The payment facilitator then reports the approval or denial to the merchant. Accordingly, the financial transaction is completed without the merchant gaining access to the full account identifier of the consumer. In addition, a private network may be used for the communication between the payment facilitator and the financial institution. In such embodiment, the full account identifier is not transmitted via a publicly-accessible network further improving the security of the consumer's account identifier.

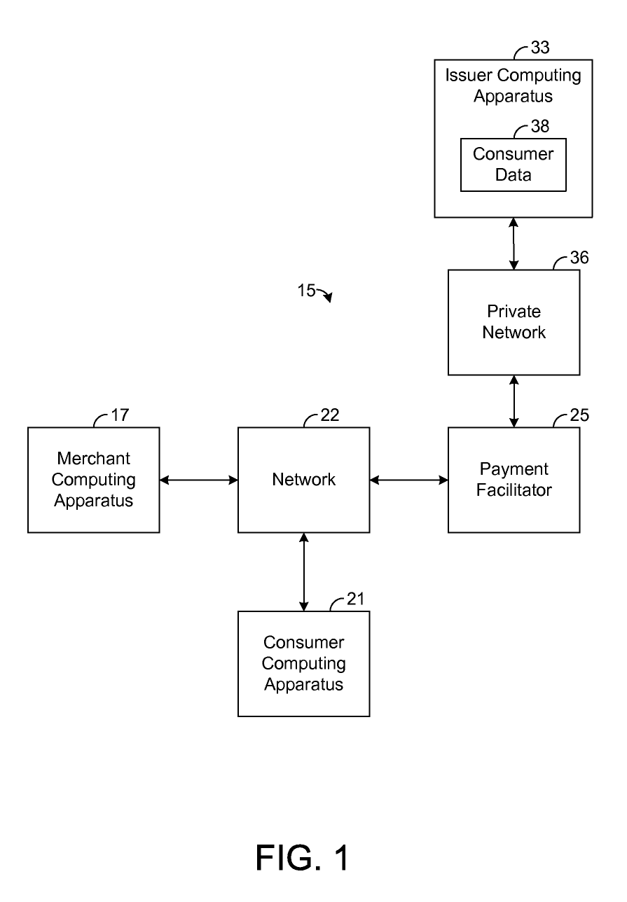

FIG. 1 depicts an exemplary embodiment of a financial payment system 15. As shown by FIG. 1, the system 15 comprises a merchant computing apparatus 17 that communicates with a consumer computing apparatus 21 via a network 22. The merchant computing apparatus 17 may be any computing apparatus, such as a desk-top or lap-top computer, a hand-held device (e.g., a personal digital assistant (PDA) or a cellular telephone), a server, or other type of apparatus capable of processing financial transactions and communicating with the network 22, as described herein. In one exemplary embodiment, the merchant computing apparatus 17 hosts a website that can be accessed by the consumer computing apparatus 21 to enable a user of the apparatus 21, referred to hereafter as “consumer,” to purchase a good or service from a merchant.

The consumer computing apparatus 21 may be any computing apparatus, such as a desk-top or lap-top computer, a hand-held device (e.g., a personal digital assistant (PDA) or a cellular telephone), a server, or other type of apparatus capable of processing financial transactions and communicating with the network 22, as described herein. The network 22 can comprise any known or future-developed communication network. In one exemplary embodiment the network 22 comprises the Internet, and packets in accordance with Internet Protocol (IP) are used to communicate over the network 22. However, other types of networks or combination of networks may be used to implement the network 22. As an example, a cellular network may be used to communicate with the consumer computing apparatus 21 and to provide an interface between the consumer computing apparatus 21 and the Internet. Yet other types of networks are possible in other embodiments.

As shown by FIG. 1, the financial payment system 15 also comprises a payment facilitator 25 that communicates with an issuer computing apparatus 33 via a private network 36. The payment facilitator 25 may be any computing apparatus, such as a desk-top or lap-top computer, a hand-held device (e.g., a personal digital assistant (PDA) or a cellular telephone), a server, or other type of apparatus capable of processing financial transactions and communicating with the networks 22 and 36, as described herein.

The private network 36 is a secure network, such as the automated clearing house (ACH) or electronic funds transfer (EFT) network, depending on the type of consumer account used to make payment. As an example, if a credit card account is used to make payment, then the network 36 may be an ACH network or a private network of a credit card company, such as Visa®, Mastercard®, American Express®, or Discover®. If a debit card account is used to make payment, then the network 36 may be an EFT network. Yet other types of networks, private or public, may be used to communicate between the payment facilitator 25 and the issuer computing apparatus 33.

The issuer computing apparatus 33 may be any computing apparatus, such as a desk-top or lap-top computer, a hand-held device (e.g., a personal digital assistant (PDA) or a cellular telephone), a server, or other type of apparatus capable of processing financial transactions and communicating with the network 36, as described herein. As shown by FIG. 1, the issuer computing apparatus 33 stores consumer account data 38 indicative of a financial account, such as a credit card or debit card account, of the consumer. The issuer computing apparatus 33 may be owned, operated, and/or maintained by the financial institution that issued the financial account to the consumer.

In one exemplary embodiment, the consumer account data 38 indicates various attributes about the financial account. For example, the consumer account data 38 may include an account identifier that uniquely identifies the consumer account from other financial accounts issued by the financial institution. In one exemplary embodiment, the account identifier is a string of alpha-numeric characters that is unique to the account identified by the account identifier. As an example, a typical account identifier for a credit card account is a sixteen (16) digit number, but other types of account identifiers may be used in other examples. During account identifier assignment, the issuer computing apparatus 33 ensures that the same account identifier is not assigned to more than one financial account issued by the financial institution.

The consumer account data also includes a value indicative of an account balance. For example, for a credit card account, the account balance indicates the amount of funds currently borrowed from the account by the consumer and, thus, owed by the consumer to the financial institution. The consumer account data 38 may include a value indicative of the credit limit authorized for the account. If a payment is made from the account such that the account balance exceeds the credit limit, then the payment results in an overdraft condition for which overdraft fees may be charged if the consumer has approved of such fees.

For a debit card account, the account value indicates the amount of funds currently deposited into the account. If a payment is made from the account such that the account balance falls below a predefined threshold, then the payment results in an overdraft condition for which overdraft fees may be charged if the consumer has approved of such fees. Exemplary systems and methods for performing financial transactions and handling overdraft conditions are described in commonly-assigned U.S. Provisional Patent Application No. 61/331,163, entitled “Financial Payment Systems and Methods for Obtaining Consumer Authorization of Overdraft Fees” and filed on May 4, 2010, which is incorporated herein by reference.

As will be described in more detail hereafter, transaction data indicative of a financial transaction between the merchant and consumer is transmitted via the network 22 or otherwise to the payment facilitator 25. The transaction data is indicative of a financial account of the consumer to be used for effectuating a payment from the consumer to the merchant. Based on the transaction data, the payment facilitator 25 defines a payment request and transmits the payment request via the private network 36 to the issuer computing apparatus 33. If the financial institution apparatus 33 approves the payment request, the issuer computing apparatus 33 effectuates payment from a financial account of the consumer to a financial account of the merchant. Notification of such approval is transmitted via the private network 36 to the payment facilitator 25, which notifies the merchant computing apparatus 17 of the approval.

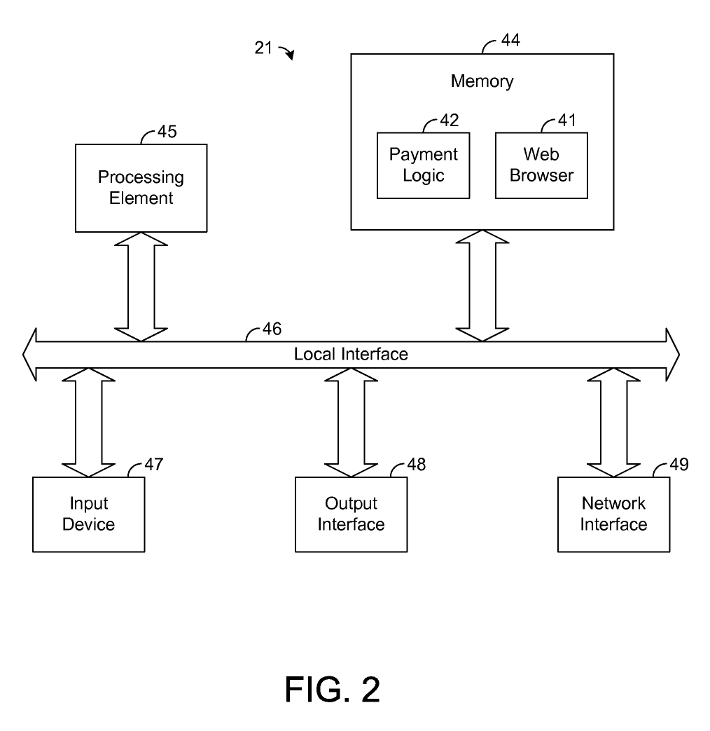

FIG. 2 depicts an exemplary embodiment of the consumer computing apparatus 21. As shown by FIG. 2, the consumer computing apparatus 21 comprises a web browser 41 and payment logic 42 stored within memory 44. In one exemplary embodiment, the payment logic 42 is a script (e.g., JavaScript) downloaded from the merchant computing apparatus 17, as will be described in more detail hereafter.

The exemplary embodiment of the consumer computing apparatus 21 depicted by FIG. 2 comprises at least one conventional processing element 45, such as a digital signal processor (DSP) or a central processing unit (CPU), that communicates to and drives the other elements within the apparatus 21 via a local interface 46, which can include at least one bus. Further, the processing element 45 is configured to execute instructions of software, such as the web browser 41 and the payment logic 42 are stored in memory 44. An input interface 47, for example, a keyboard, keypad, or mouse, can be used to input data from a user of the apparatus 21, and an output interface 48, for example, a printer or display screen (e.g., a liquid crystal display (LCD)), can be used to output data to the user. In addition, a network interface 49, such as a modem, enables the apparatus 21 to communicate with the network 22.

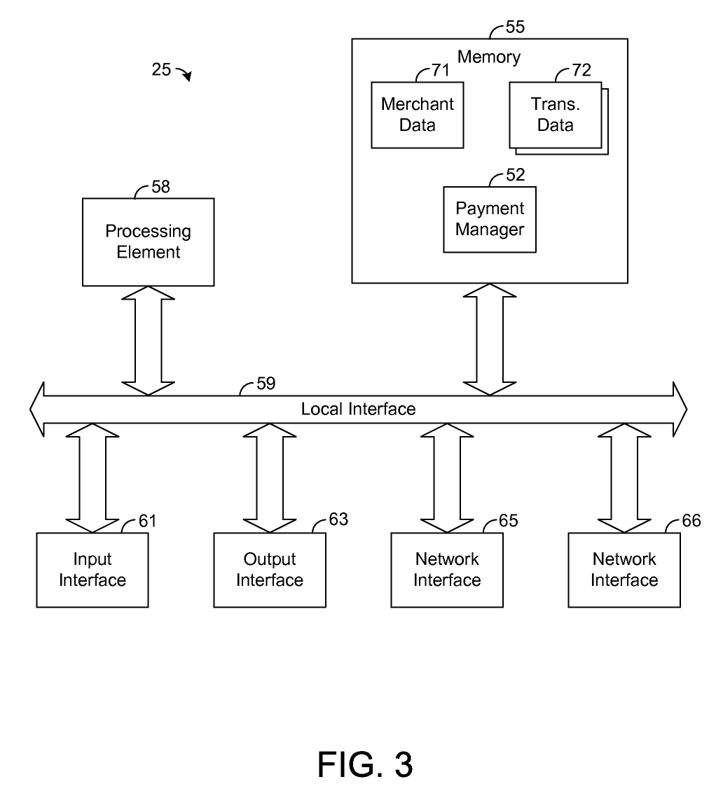

FIG. 3 depicts an exemplary embodiment of the payment facilitator 25. As shown by FIG. 3, the payment facilitator 25 comprises a payment manager 52 that generally controls the operation of the payment facilitator 25, as will be described in more detail hereafter. It should be noted that the payment manager 52 can be implemented in software, hardware, firmware or any combination thereof. In an exemplary embodiment illustrated in FIG. 3, the payment manager 52 is implemented in software and stored in memory 55 of payment facilitator 25.

Note that the payment manager 52, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the payment facilitator 25 depicted by FIG. 3 comprises at least one conventional processing element 58, such as a digital signal processor (DSP) or a central processing unit (CPU), that communicates to and drives the other elements within the payment facilitator 25 via a local interface 59, which can include at least one bus. Further, the processing element 58 is configured to execute instructions of software, such as the payment manager 52, stored in memory 55. An input interface 61, for example, a keyboard, keypad, or mouse, can be used to input data from a user of the payment facilitator 25, and an output interface 63, for example, a printer or display screen (e.g., a liquid crystal display (LCD)), can be used to output data to the user. In addition, a network interface 65, such as a modem, enables the payment facilitator 25 to communicate with the network 22, and a network interface 66, such as a modem, enables the payment facilitator 25 to communicate with the network 36.

As shown by FIG. 3, merchant data 71 and transaction data 72 are stored in memory 55. The merchant data 71 is indicative of various attributes pertaining to the merchant. For example, the merchant data 71 may include a username that uniquely identifies the merchant. The merchant data 71 may also include a type indicator that indicates a merchant type for the merchant. As an example, the type indicator may indicate the types of goods or services sold or otherwise provided by the merchant. The merchant data 71 also includes an account identifier identifying a financial account for the merchant to which funds from a financial transaction may be deposited, as will be described in more detail hereafter. The merchant data 71 also includes authentication information that can be used to authenticate the merchant when the payment facilitator 25 receives messages from the merchant. In one exemplary embodiment, the authentication information includes a password and a unique token that is assigned to the merchant. The authentication information may also include an address, such as an IP address, for the merchant computing apparatus 17. Other types of authentication information may be used in other embodiments.

Note that the merchant attributes for a given merchant are established during a registration process when the merchant registers with the payment facilitator 25. Such registration may take place any number of ways. For example, the merchant may use the merchant computing apparatus 17 to communicate with the payment facilitator 25 so that the attributes may be exchanged between the merchant computing apparatus 17 and the payment facilitator 25. Alternatively, the merchant attributes may be communicated in a telephone call or otherwise between the merchant and a user of the payment facilitator 25 who uses the input interface 61 and/or output interface 63 to exchange the merchant attributes with the payment facilitator 25. Other techniques may be used to establish the merchant data 71, and the merchant data 71 may be updated from time-to-time as may be desired.

Multiple sets (e.g., files or entries) of transaction data 72 are stored in the memory 55. Each set of transaction data 72 corresponds to a respective financial transaction. Each set of transaction data 72 has an identifier, referred to hereafter as the “transaction identifier,” that uniquely identifies the financial transaction corresponding to the set of transaction data. Any number of sets of transaction data 72 may be stored in the memory 55. As will be described in more detail hereafter, other transaction attributes of a financial transaction may be indicated by the transaction data 72. The transaction attributes for the same transaction are preferably correlated in the payment facilitator 25 for easy access to such attributes. As an example, the sets of transaction data 72 may be stored in a database, and all of the transaction attributes for the same financial transaction may be stored in the same entry of the database. Thus, a transaction attribute, such as a transaction identifier, may be used as key to lookup and find the other attributes for the same transaction.

For illustrative purposes, assume that the consumer utilizes the web browser 41 to navigate to the website hosted by the merchant computing apparatus 17 for selling a good or service. While browsing the website, assume that the consumer provides an input for indicating a desire to purchase a good or service from the merchant. In response the merchant computing apparatus 17 downloads the payment logic 42 to the consumer computing apparatus 21 via the network 22, and the payment logic 42 prompts the consumer for his or her account identifier for the financial account to be used for payment. In this regard, the payment logic 42 displays a web page that has fields for allowing the consumer to enter various information, such as the consumer's name, address, and account information, including the account identifier and expiration date, if any, for the account.

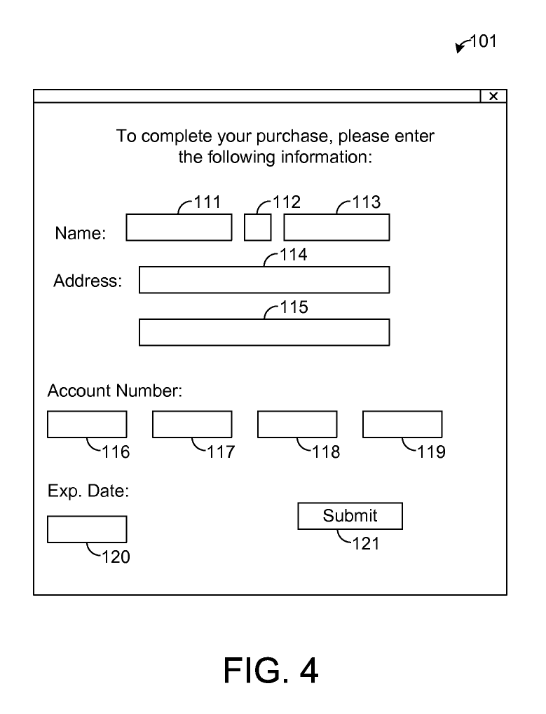

FIG. 4 depicts an exemplary GUI 101 that may be displayed to the consumer in order to solicit financial information for the purchase. The exemplary GUI 101 has a plurality of text boxes 111-120 that can be used by the consumer to enter the financial information for the purchase. In this regard, the consumer's name may be entered via text boxes 111-113, and the consumer's address may be entered via text boxes 114 and 115. Further, the account identifier of the financial account to be used to effectuate payment may be entered via text boxes 116-119, and the expiration date for such financial account may be entered via text box 120.

To enter information in a given text box, except as is otherwise described herein, the consumer may use a mouse or other input device of the consumer computing apparatus 21 to select the text box of interest and to then type information into the text box using a keyboard or other user input device of the consumer computing apparatus 21. Once the consumer is finished entering information, the consumer may select a “submit” button 121 to indicate that all of the information has been entered. After selection of the “submit” button 121, the payment logic 42 transmits the entered information to the merchant computing apparatus 17 via the network 22, as will be described in more detail hereafter. However, as will be noted below, at least a portion of the account identifier is not transmitted to the merchant computing apparatus 17 but is instead transmitted to the payment facilitator 25.

Note that the exemplary GUI 101 shown by FIG. 4 may be used when the financial account to be used for the purchase is a credit card account, though the GUI 101 may be used for other types of accounts as well. In this regard, a typical credit card account is usually identified by a sixteen (16) digit number. In the GUI 101 of FIG. 4, each text box 116-119 may be a four-digit text box such that the consumer may enter the first four digits of his or her credit number in box 116 and then successively enter the remaining digits in groups of four into boxes 117-119, respectively. Thus, the last four digits of the consumer's credit card number are entered via box 119. In other embodiments, other types of web pages and/or graphical elements may be used to solicit the information from the consumer, and as previously noted above, other types of financial accounts may be used for payment. As an example, a debit card may be used to effectuate payment, if desired. Often, an issuing financial institution for a debit card requires a personal identification number (PIN) to be entered by a user, but there are at least some debit card transactions that are authorized based on a consumer's signature and do not require entry of a PIN. If a PIN is required for the transaction, then such a PIN may be requested as well. U.S. Patent Application No. 61/331,163 describes exemplary techniques for obtaining a PIN from a consumer during a financial transaction.

In addition to transmitting the payment logic 42 to the consumer computing apparatus 21, the merchant computing apparatus 17 also transmits to the payment facilitator 25 via the network 22 a message, referred to as an “Initialize Message,” for initializing a financial transaction between the merchant and consumer. In one exemplary embodiment, the Initialize Message is transmitted to the payment facilitator 25 after the payment logic 42 is transmitted to the consumer computing apparatus 21, but the Initialize Message may be transmitted along with or before transmission of the payment logic 42 in other embodiments.

Note that each message transmitted from the merchant computing apparatus 17 to the payment facilitator 25, including the Initialize Message, has a header that comprises certain attributes of the merchant. In one exemplary embodiment, the header includes a username, a password, an address (e.g., an IP address) of the merchant computing apparatus 17, and a predefined token, which have been established prior to the financial transaction being described (e.g., when the merchant registers with the payment facilitator 25), as described above. The header also includes an address (e.g., an IP address) of the payment facilitator 25 to enable the message to be routed to the payment facilitator 25 by the network 22. Upon receiving a message from the merchant computing apparatus 17, the payment manager 52 compares various attributes in the header, such as the username, password, address of the merchant computing apparatus 17, and predefined token, to the merchant data 71 in order to authenticate the source of the message. In this regard, if such header information from the merchant matches the merchant data 71 correlated with such merchant, then the payment facilitator 25 responds to the message and processes the message as appropriate depending on the message's type. Otherwise, the payment facilitator 25 discards the message without further processing it.

In response to the Initialize Message, the payment manager 52 (FIG. 3) of the payment facilitator 25 generates credentials for the financial transaction and stores the credentials in memory 55 as a set of transaction data 72. In one exemplary embodiment, the credentials include a new transaction identifier and a new encryption key. For the sake of clarity, this transaction identifier shall be referred to hereafter as “Transaction Identifier A.” Note that the set of transaction data 72 containing the newly generated credentials does not necessarily have other transaction attributes stored in it at this point.

The payment manager 52 transmits the foregoing credentials to the merchant computing apparatus 17 via the network 22, and the merchant computing apparatus 17 forwards the credentials to the payment logic 42. In response, the payment logic 42 contacts the payment facilitator 25, and the payment manager 52 replies by transmitting data defining a GUI (e.g., an interactive web page). At some point, the payment logic 42 displays such GUI to the consumer via the output interface 48 (FIG. 2) of the consumer computing apparatus 21 in order to solicit a portion of the account identifier for the consumer's account.

As an example, in one exemplary embodiment, the GUI from the payment facilitator 25 is displayed when the user selects the last text box 119 for entering his or her account identifier. Thus, assuming that the account identifier is a 16 digit number, such as a credit card number, the consumer successively selects boxes 116-118 and types in the first 12 digits of his or her account identifier. The consumer then selects box 119 with a mouse or other user input device to enter the last four digits of his or her account identifier. In response to selection of the box 119, the GUI from the payment facilitator 25 is displayed to the consumer via the output interface 48 (FIG. 2). As an example, the GUI may be a web page that is displayed by the consumer's web browser 41, like the GUI 101 shown by FIG. 4.

The GUI from the payment facilitator 25 permits the consumer to enter a portion of the account identifier, which is the identifier's last four digits in the instant example. In one exemplary embodiment, such GUI permits the consumer to enter the portion of the account identifier via keyless user inputs (e.g., inputs received via mouse clicks) rather than keyed user inputs (e.g., inputs received via typing). “Keyless user inputs” generally refer to user inputs that are received without typing keys, such as the keys of a keypad or keyboard. “Keyed user inputs,” on the other hand, generally refers to user inputs that are received by a user typing keys, such as the keys of a keypad or keyboard.

Since a portion of the consumer's account identifier is entered via keyless user inputs, attempts of capturing the account identifier via key logging may be prevented or frustrated. In this regard, if the user types the first 12 digits of his or her account identifier into the text boxes 116-118 of FIG. 4 and then enters the last four digits via keyless user inputs, such as mouse click, as described above in the instant example, then a malicious key logging software routine might detect the first 12 digits without detecting the last four digits.

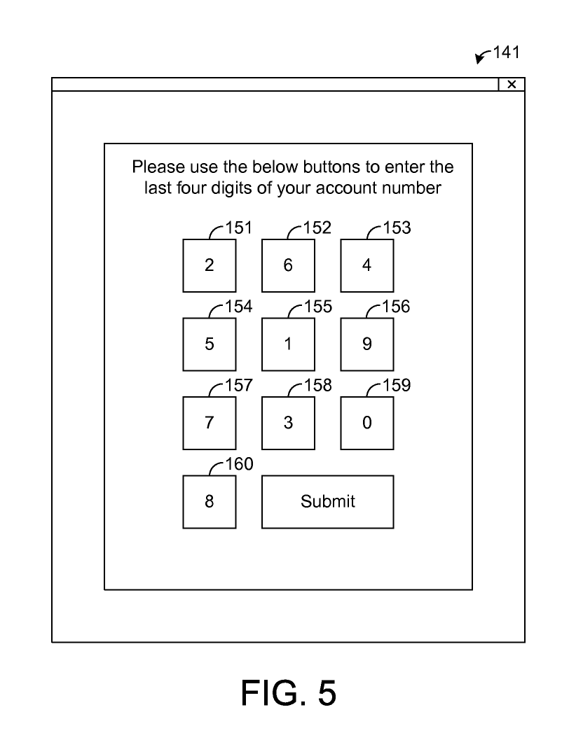

In one exemplary embodiment, the GUI from the payment facilitator 25 has a graphical entry pad having graphical buttons or other graphical elements that can be selected by the consumer to enter characters, such as numbers. FIG. 5 depicts an exemplary GUI 141 that may be received from the payment facilitator 25. The exemplary GUI 141 of FIG. 5 has a graphical character-entry pad 144 that has a plurality of graphical buttons 151-160. Associated with and displayed on each graphical button 151-160 is a one-digit number. The consumer enters a portion of his or her account identifier by selecting via a mouse or otherwise the buttons 151-160 associated with the numbers in the account identifier portion being entered (e.g., the last four digits in the instant example). In the exemplary embodiment shown by FIG. 5, the associated numbers are scrambled so that they do not appear in consecutive order from lowest to highest, but other arrangements are possible in other embodiments.

Upon entry of such portion of the consumer's account identifier, data indicative of the entered characters, referred to hereafter as “payment facilitator account data” or “PF account data,” is transmitted from the consumer computing apparatus 21 to the payment facilitator 25 via the network 22 bypassing the merchant computing apparatus 17. In one exemplary embodiment, the actual character values are not included in the PF account data communicated to the payment facilitator 25. Instead, for each button selection, rather than transmitting the button's associated digit number, the screen coordinate of the selected button is transmitted to the payment facilitator 25. Such screen coordinate is later translated by the payment facilitator 25 into the digit number associated with the selected button. Thus, the payment facilitator 25 recovers, from the screen coordinates, the values of a portion of the consumer's account identifier entered via the GUI 141 (i.e., the last four digits of the account identifier in the instant example). Exemplary techniques for translating between screen coordinates and input selections are described in commonly-assigned U.S. Pat. No. 6,209,104, entitled “Secure Data Entry and Visual Authentication System and Method” and filed on Dec. 1, 1997, which is incorporated herein by reference. Before transmitting the PF account data to the payment facilitator 25, the payment logic 42 is configured to encrypt such data using the encryption key in the credentials described above.

The payment manager 52 receives the encrypted PF account data from the consumer computing apparatus 21 and decrypts such data. Based on the decrypted data, the payment manager 52 determines the portion of the consumer's account identifier indicated by such data. For example, if the consumer computing apparatus 21 transmitted characters of the consumer's account identifier rather than screen coordinates, then the payment manager 52 may determine a portion of the consumer's account identifier simply by decrypting the message or messages containing such characters. If, however, the screen coordinates are transmitted, as described above, then the payment manager 52 decrypts the message or messages containing the coordinates and then translates the coordinates into the character string originally selected by the consumer via the GUI 141.

Note that each message transmitted from the consumer computing apparatus 21 to the payment facilitator 25 includes the transaction identifier (i.e., Transaction Identifier A in the current example) from the credentials generated at the payment facilitator 25. Using the Transaction Identifier A transmitted along with the messages carrying the PF account data, the payment manager 52 stores the PF account data in the set of transaction data 72 that is correlated with Transaction Identifier A.

After determining and storing the consumer's PF account data, the payment manager 52 transmits a message, referred to hereafter as an “Account Data Acknowledgment,” to the payment logic 42 at the consumer computing apparatus 21. Such Acknowledgment indicates that the consumer's PF account data has been successfully received by the payment facilitator 25. Note that the communication of the PF account data bypasses the merchant computing apparatus 17. Thus, the merchant computing apparatus 17 never has access to such information thereby preventing the merchant from determining or having access to the complete account identifier that identifies the consumer's financial account.

Once the payment logic 42 receives the Account Data Acknowledgment, the payment logic 42 forwards a portion of the consumer's account identifier to the merchant computing apparatus 17 via the network 22. Specifically, in one exemplary embodiment, the payment logic 42 transmits the complete account identifier except for the portion that is described above as being transmitted to the payment facilitator 25. Thus, in the exemplary embodiment described above in which the last four digits of the account identifier entered via the GUI 141 are transmitted to the payment facilitator 25, the remainder of the account identifier (e.g., the first 12 digits of the account identifier) entered via the GUI 101 is transmitted to the merchant computing apparatus 17.

In response, the merchant computing apparatus 17 transmits a message, referred to hereafter as a “Purchase Authorization Message,” to the payment facilitator 25 via the network 22. Such Purchase Authorization Message includes transaction data indicative of the financial transaction between the merchant and consumer. In one exemplary embodiment, the Purchase Authorization Message includes the transaction identifier (i.e., Transaction Identifier A in the current example), the portion of the account identifier transmitted from the consumer computing apparatus 21 to the merchant computing apparatus 17, and the purchase amount of the transaction (i.e., the amount to be paid from the consumer's account to the merchant's account). For a credit card transaction, the Purchase Authorization Message may also include the expiration date of the credit card. In other embodiments, other types of transaction data may be included in the Purchase Authorization Message.

Upon receiving the Purchase Authorization Message, the payment manager 52 stores the transaction data from such message in the set of transaction data 72 having the same transaction identifier (i.e., Transaction Identifier A in the current example). Further, the payment manager 52 combines the portion of the account identifier received from the Purchase Authorization Message with the portion of the account identifier received from the consumer computing apparatus 21 via the GUI 141 in order to form a complete account identifier identifying the consumer's financial account. As will be described in more detail, the complete account identifier is then used to complete the financial transaction.

In this regard, the transaction manager 52 creates a payment request, referred to hereafter as a “POS Payment Request,” and transmits the POS Payment Request to the issuer computing apparatus 33 requesting payment of the purchase amount from the consumer's account to the merchant's account. The POS Payment Request includes various information for enabling the issuer computing apparatus 33 to determine whether to accept the POS Payment Request and to effectuate payment if such request is approved.

In one exemplary embodiment, the payment manager 52 inserts into the POS Payment Request at least the following information: the transaction identifier (i.e., Transaction Identifier A in the current example); account identifier of the merchant's financial account to which funds are to be deposited for the financial transaction; account identifier of the consumer's financial account from which funds are to be withdrawn for the financial transaction; and the purchase amount for the financial transaction. For a credit card transaction, the POS Payment Request may also include the card's expiration date and/or any other information necessary to process the credit card transaction. Note that the transaction identifier, a portion of the consumer account identifier (e.g., first 12 digits in the instant example), and purchase amount can be obtained from the Purchase Authorization Message transmitted from the merchant computing apparatus 17. Further, the remainder consumer's account identifier (e.g., the last 4 digits in the instant example) can be retrieved from the memory 55 using the transaction identifier from the Purchase Authorization Message as a key to find such portion. In addition, the merchant account identifier can be retrieved from the merchant data 71 using information from the header of the Purchase Authorization Message, such as the merchant's username or address, as a key to find the merchant's account identifier.

Note that the POS Payment Request may be transmitted over various types of private networks 36. In one exemplary embodiment, the consumer's account is a debit card account, and the private network 36 used for communicating the POS Payment Request and other messages between the issuer computing apparatus 33 and the payment facilitator 25 is the EFT network. In another embodiment, the consumer's account is a credit card account, and the private network 36 used for communicating the POS Payment Request and other messages between the issuer computing apparatus 33 and the payment facilitator 25 is the ACH network or a private network of a credit card company. However, other types of accounts and networks 36 may be used in other embodiments.

In response to the POS Payment Request, the issuer computing apparatus 33 determines whether to approve such request. The determination whether to approve the POS Payment Request may be based on several factors. For example, the issuer computing apparatus 33 may compare the account identifier and expiration data to the consumer data 38 to ensure that the identified account is valid, and the issuer computing apparatus 33 may compare the purchase amount in the POS Payment Request to the consumer data 38 to determine whether the identified account has sufficient funds or credit for the purchase. In any event, the issuer computing apparatus 33 compares the data in the POS Payment Request and decides to approve or decline the Request based on such comparisons. If the issuer computing apparatus 33 ultimately approves the POS Payment Request, the issuer computing apparatus 33 effectuates the payment indicated by the POS Payment Request. That is, the issuer computing apparatus 33 withdraws funds from the consumer account, which is indicated by the POS Payment Request, and initiates a transfer of the funds to the merchant's account, which is also indicated by the POS Payment Request.

The issuer computing apparatus 33 also transmits a reply to the payment facilitator 25 via the network 36 indicating whether the POS Payment Request has been approved. In response, the payment manager 52 updates the transaction data 72 to indicate the approval status of the transaction and then transmits a message to the merchant computing apparatus 17 via the network 22 indicating whether the POS Payment Request has been approved, thereby completing the financial transaction.

Accordingly, the financial transaction is completed without the merchant accessing the complete account identifier for the consumer's account, thereby mitigating many of the risks currently plaguing the financial industry, particularly for transactions that do not utilize a PIN for consumer authentication. In this regard, since the merchant never has access to the complete account identifier, vulnerabilities associated with the merchant, such as unscrupulous employees or hacking of the merchant's database, do not result in the complete account identifier being learned by an unauthorized user. In addition, transmission of the complete account identifier across the same connection of the network 22 is prevented making it more difficult for hackers accessing the network 22 to learn the account identifier.

It should be noted that the embodiments described above are exemplary, and various modifications and changes to the described embodiments are possible. As an example, various types of account identifiers can be used, and any portion of an account identifier can be transmitted to the payment facilitator 25. As an example, the data entered via the text box 118 of FIG. 4 or via a plurality to text boxes 117 and 118 may be transmitted to the payment facilitator 25 instead of the data entered via the text box 119. In one exemplary embodiment, the complete account identifier is transmitted to the payment facilitator 25 along with the transaction identifier, and the payment facilitator 25 uses the transaction identifier to correlate the account identifier with the POS Payment Request received from the merchant computing apparatus 17. In addition, GUI types and graphical interface elements other than those specifically described herein may be used to solicit information from the consumer. In one exemplary embodiment, a separate GUI is unnecessary. As an example, the payment logic 42 may be configured to transmit to the payment facilitator 25 the data entered via any one or more of the text boxes 116-119 and to transmit to the merchant computing apparatus 17 the remainder of the data entered via the GUI 101. Yet other changes and modifications would be apparent to a person of ordinary skill upon reading this disclosure.

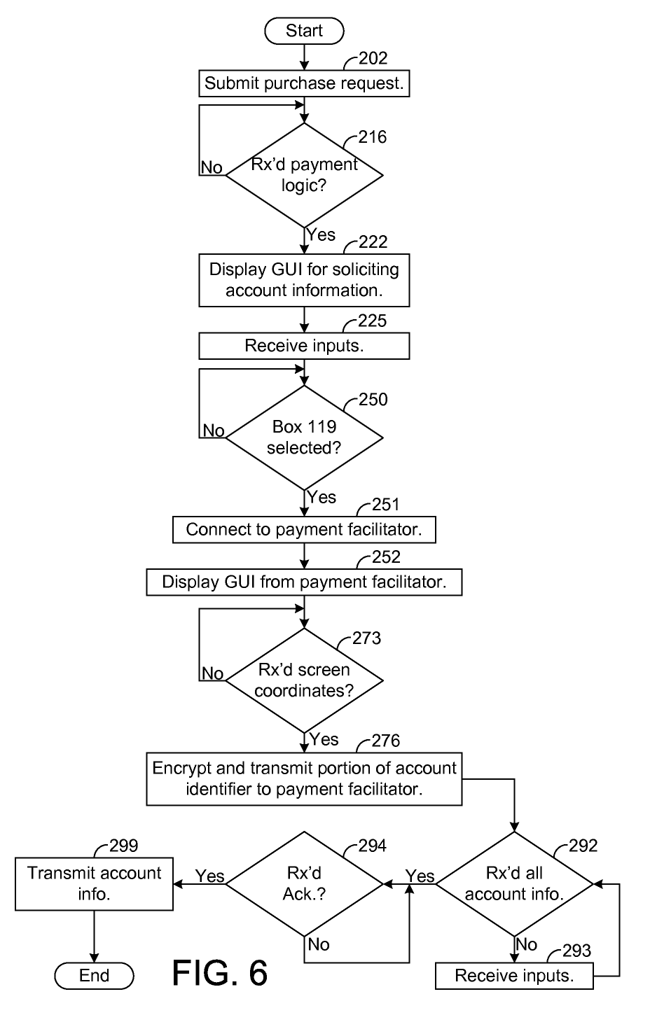

An exemplary use and operation of the system 15 will now be described with particular reference to FIGS. 6-8.

For illustrative purposes, assume that the consumer wishes to uses a 16 digit credit card number to make a purchase of a good or service from the merchant. Also assume that the system 15 is configured such that the last four digits of the credit card number bypass the merchant and are sent directly from the consumer computing apparatus 21 to the payment facilitator 25 to complete the financial transaction. Note that a credit card transaction can be a PIN-less transaction. A “PIN-less transaction” generally refers to a financial transaction in which an account identifier is used to identify the consumer's financial account involved in the transaction, but a PIN is not used to authenticate the consumer during the transaction. In the current example, assume that the credit card transaction is PIN-less such that the consumer does not provide a PIN in addition to the account number of the credit card account used to effectuate the purchase. However, in other embodiments, the techniques described herein may be used in transactions that require a PIN for authentication.

Initially, the consumer accesses a web page hosted by the merchant computing apparatus 17 using the web browser 41 and a connection through the network 22 between the merchant computing apparatus 17 and the consumer computing apparatus 21. Note that at least a portion of any connection described herein may be wireless, if desired. For example, the consumer computing apparatus 21 may communicate wirelessly with the network 22.

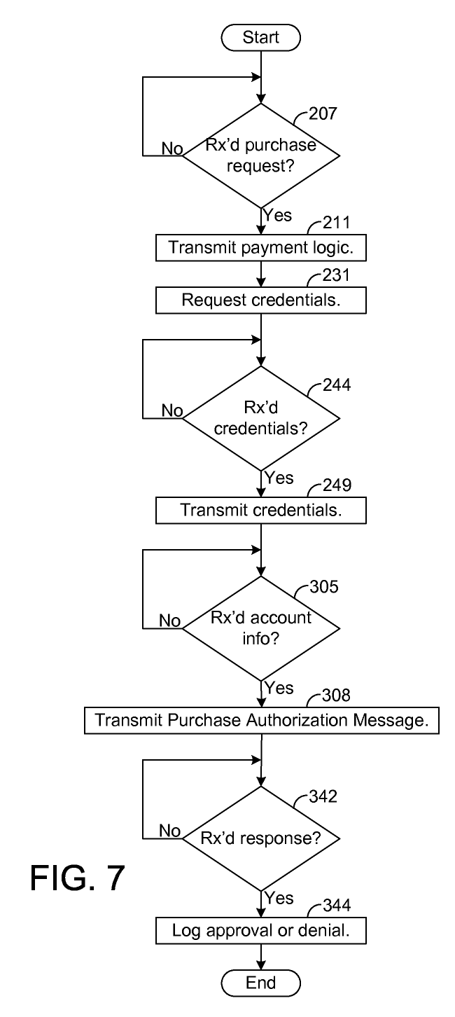

Using such connection and based on inputs from the consumer, the consumer computing apparatus 21 submits a request to purchase a good or service offered by the merchant, as shown by block 202 of FIG. 6. Upon receiving such request, the merchant computing apparatus 17 transmits the payment logic 42 to the consumer computing apparatus 21 using the same connection through the network 22, as shown by blocks 207 and 211 of FIG. 7. Upon receiving such logic 42, the consumer computing apparatus 21 executes the logic 42 such that a GUI 101 (FIG. 4) for soliciting account information from the consumer is displayed by the consumer computing apparatus 21, as shown by blocks 216 and 222 of FIG. 6. The consumer then begins entering inputs into the GUI 101, such as his or her name, address, account identifier, and expiration date for the financial account, and such inputs are received by the payment logic 42, as shown by block 225 of FIG. 6.

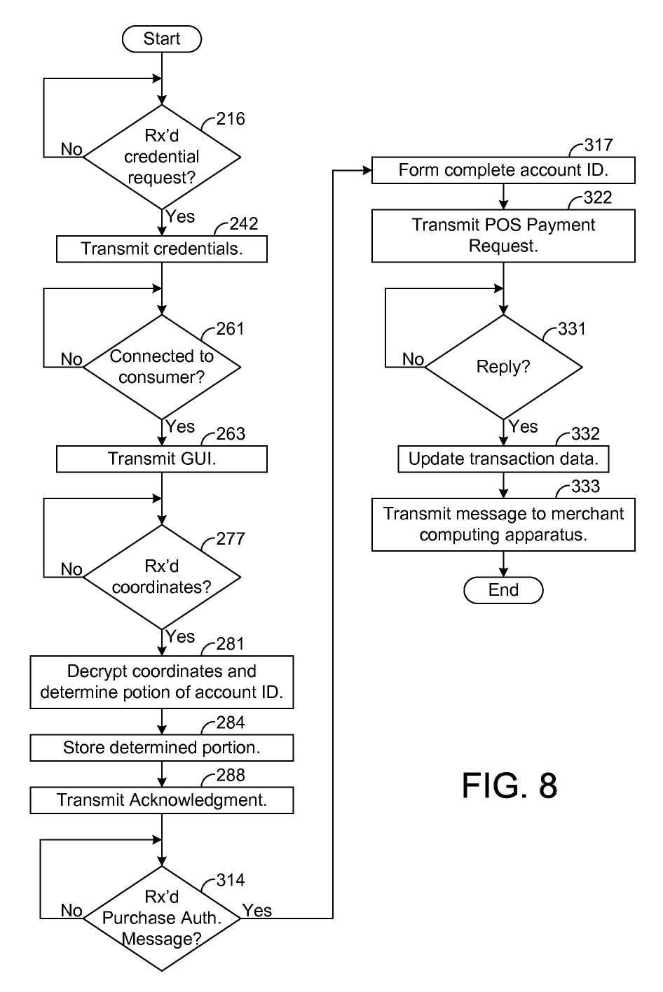

As shown by block 231 of FIG. 7, the merchant computing apparatus 17 also transmits a request for credentials pertaining to the current financial transaction. In this regard, the merchant computing apparatus 17 initiates a new connection through the network 22 to the payment facilitator 25 and transmits the credential request via such connection. Upon receiving the credential request, the payment facilitator 25 generates new credentials for the transaction, such as a new transaction identifier, and transmits the credentials, including an encryption key for the transaction, to the merchant computing apparatus 17, as shown by blocks 238 and 242 of FIG. 8. Upon receiving the credentials, the merchant computing apparatus 17 forwards the credentials to the payment logic 42 at the consumer computing apparatus 21, as shown by blocks 244 and 249 of FIG. 7.

As the consumer is entering the information prompted by the GUI 101, the consumer eventually selects the text box 119 via a mouse or otherwise in order to enter the last four digits of his or her credit card number. In response, the payment logic 42 causes display of the GUI 141. In this regard, as shown by blocks 250-252, the payment logic 42 initiates a new connection through the network 22 with the payment facilitator 25 and transmits across such connection credentials (e.g., transaction identifier) transmitted in block 249 of FIG. 7. Notably, such connection bypasses the merchant computing apparatus 17 such that the merchant computing apparatus 17 cannot access the information transmitted across the connection. In response, the payment facilitator 25 downloads the GUI 141 (FIG. 5) to the consumer computing apparatus 25 such that the GUI 141 is displayed via the web browser 41, as shown by blocks 261 and 263 of FIG. 8.

When the GUI 141 is displayed, the consumer provides inputs for selecting the graphical buttons 151-160 corresponding to the last four digits of his or her account number. Upon receiving the screen coordinates of the selected buttons 151-160, the payment logic 42 closes the GUI 141. The payment logic 42 also encrypts the coordinates and transmits the encrypted coordinates to the payment facilitator 25 via the network connection bypassing the merchant computing apparatus 17, as shown by blocks 273 and 276 of FIG. 6. Upon receiving such encrypted coordinates, the payment facilitator 25 decrypts the coordinates and determines the last four digits of the consumer's credit card number based on the decrypted coordinates, as shown by blocks 277 and 281 of FIG. 8. The payment facilitator 25 also stores the determined digits in the transaction data 72 and transmits an Account Data Acknowledgment to the consumer computing apparatus 21, as shown by blocks 284 and 288 of FIG. 8.

As shown by blocks 292-294 of FIG. 6, the payment logic 42 continues to receive inputs indicative of the consumer's account information until the all of the requested account information is received, as indicated by the consumer's selection of the “submit” button 121 (FIG. 4), and the payment logic 42 receives the Account Data Acknowledgment from the payment facilitator 25. Once the foregoing occurs, the payment logic 42 transmits to the merchant computing apparatus 17 the account information received via the GUI 101 (FIG. 4), including the first 12 digits of the consumer's credit card number, as shown by block 299 of FIG. 6.

Upon receiving such information from the consumer computing apparatus 21, the merchant computing apparatus 17 transmits a Purchase Authorization Message to the payment facilitator 25, as shown by blocks 305 and 308 of FIG. 7. Such Purchase Authorization Message includes account information, including the first 12 digits of the consumer's credit card number, received via the GUI 101. Upon receiving the Purchase Authorization Message, the payment facilitator 25 combines the first 12 digits of the consumer's credit card number with the last four digits of the consumer's credit card number stored in the transaction data 72, thereby forming the complete credit card number, as shown by blocks 314 and 317 of FIG. 8.

The payment facilitator 25 then transmits a POS Payment Request to the issuer computing apparatus 33, as shown by block 322 of FIG. 8. Such POS Payment Request includes the complete credit card number formed in block 317. In response to the POS Payment Request, the issuer computing apparatus either approves or declines the payment request, and transmits a reply indicative of such decision to the payment facilitator 25. Upon receiving the reply, the payment facilitator 25 updates the transaction data 73 to indicate whether the payment request associated with the transaction is accepted, and transmits a message to the merchant computing device 17 indicating such decision, as shown by blocks 331-333 of FIG. 8. Upon receiving the foregoing message, the merchant computing apparatus 17 logs whether the payment request was approved, as shown by blocks 342 and 344 of FIG. 7.

It should be noted that several of the exemplary embodiments described above with respect to FIG. 1 can be implemented where the payment facilitator 25 is operated by an entity, referred to as a “processor” for credit card companies. In this regard, a processor, also sometimes referred to as an “acquirer,” generally refers to an entity that interacts with and registers merchants who wish to utilize the payment services of a financial account issuer, such as a bank, credit card company, or other financial institution. The functionality provided by the payment facilitator 25 in handling the consumer's account identifier, as described above, may be appealable to both the issuer and the consumer in that the payment facilitator 25 affords an additional layer of protection for the account identifier and helps to address some of the most common and extensive security threats in the industry. In addition, since the merchant does not receive and process the consumer's full account identifier, many regulations that govern financial transactions involving account identifiers of financial accounts may not be apply to the merchant, thereby facilitating the transaction from the merchant's perspective.

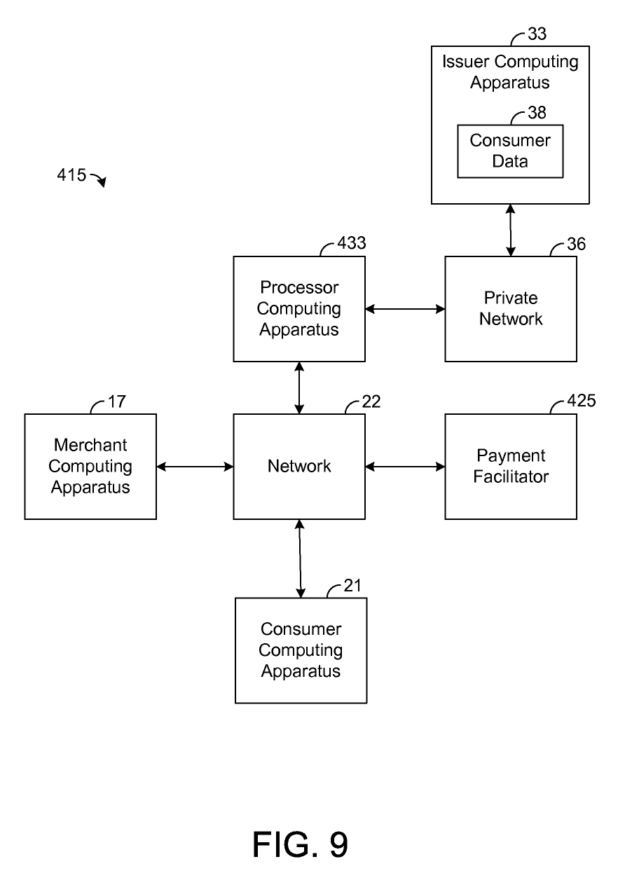

FIG. 9 depicts an exemplary embodiment of a financial payment system 415 in which a payment facilitator 425 is operated by a third party other than a processor. In such embodiment, a processor computing apparatus 433 is coupled to the networks 22 and 36, as shown. The payment facilitator 25 may be any computing apparatus, such as a desk-top or lap-top computer, a hand-held device (e.g., a personal digital assistant (PDA) or a cellular telephone), a server, or other type of apparatus capable of processing financial transactions and communicating with the networks 22 and 36, as described herein. The system 415 is configured and operates the same as the system 15 depicted by FIG. 1 up to the point that the payment facilitator 425 receives a Purchase Authorization Message from the merchant computing apparatus 17 and forms the complete account identifier for the consumer's financial account to be used in making payment. Rather than transmitting a payment request to the issuer computing apparatus 33, as described above, the payment facilitator transmits a payment request to the processor computing apparatus 433 via the network 22 or otherwise. Such payment request includes sufficient information, such as the consumer's name, account identifier, merchant identifier, amount of transaction, and expiration date, if any, for the consumer's account, for enabling the processor computing apparatus 433 to then submit a suitable payment request to the issuer computing apparatus 33, as will be described in more detail below. Note that other networks, public or private, may be used for transmission of the payment request by the payment facilitator 425.

Upon receiving the payment request, the processor computing apparatus 433 forwards the payment request via the private network 36 or otherwise to the issuer computing apparatus 33, as is described above for the transmission of a payment request from the payment facilitator 25 of FIG. 1 to the issuer computing apparatus 33. Note that the payment request from the processor computing apparatus 433 to the issuer computing apparatus 33 may have the same format relative to the payment request from the payment facilitator 25 to the processor computing apparatus 433, or the processor computing apparatus 433 may reformat payment request before forwarding it to the issuer computing apparatus 33.

Upon approving or declining the payment request, the issuer computing apparatus 33 transmit a message indicative of the approval or decline to the processor computing apparatus 433 via the private network 36 or otherwise. The processor computing apparatus 433 then transmits a message indicating such approval or decline to the payment facilitator 25 via the network 22 or otherwise. The process then continues as described above for the embodiment of FIG. 1 in which the payment facilitator 25 updates the transaction data 72 and transmits a message indicating the approval or decline to the merchant computing apparatus 17. Accordingly, the system 415 depicted by FIG. 9 operates essentially the same as the system depicted by FIG. 1, except that the processor computing apparatus 433 sits between the payment facilitator 25 and the issuer computing apparatus 33 and handles communication with the issuer computing apparatus 33. In other embodiment, yet other changes and modifications to the exemplary embodiments described herein are possible.

Now, therefore, the following is claimed:

1. A system for protecting account identifiers in financial transactions, comprising:
a merchant computing apparatus;
a payment facilitator; and
a consumer computing apparatus configured to prompt a consumer to input an account identifier uniquely identifying a financial account of a financial institution to be used in a financial transaction for purchasing a good or service from a merchant associated with the merchant computing apparatus, the consumer computing apparatus further configured to transmit data indicative of at least a first portion of the account identifier to the payment facilitator via a connection that bypasses the merchant computing apparatus,
wherein the payment facilitator is configured to determine the account identifier based on the data indicative of the first portion of the account identifier, wherein the payment facilitator is further configured to transmit a request for initiating payment from the financial account to be used in the financial transaction to a financial account of the merchant, and wherein the request comprises the account identifier determined by the payment facilitator.

2. The system of claim 1, wherein the financial transaction is PIN-less.

3. The system of claim 1, wherein the consumer computing apparatus is configured to receive keyless user inputs for selecting graphical elements and to define the data indicative of the first portion of the account identifier based on the keyless user inputs.

4. The system of claim 3, wherein the computing apparatus is configured to receive keyed user inputs and to define data indicative of a second portion of the account identifier based on the keyed user inputs, and wherein the payment facilitator is configured to determine the account identifier based on the data indicative of the first portion of the account identifier and the data indicative of the second portion of the account identifier.

5. The system of claim 1, wherein the consumer computing apparatus is configured to transmit data indicative of a second portion of the account identifier to the merchant computing apparatus, wherein the merchant computing apparatus is configured to transmit the data indicative of the second portion of the account identifier to the payment facilitator, wherein the payment facilitator is configured to determine the account identifier based on the data indicative of the first portion of the account identifier and the data indicative of the second portion of the account identifier.

6. The system of claim 1, wherein the merchant computing apparatus is configured to transmit logic to the consumer computing apparatus, wherein the logic is configured to display a first graphical user interface (GUI) for prompting the consumer to input the account identifier.

7. The system of claim 6, wherein the logic is configured to initiate the connection that bypasses the merchant computing apparatus.

8. The system of claim 7, wherein the payment facilitator is configured to transmit, to the consumer computing apparatus, data defining a second GUI for prompting the consumer to enter the first portion of the account identifier.

9. The system of claim 8, wherein the second GUI is displayed via the consumer computing apparatus in response to selection of a graphical element of the first GUI by the consumer.

10. The system of claim 8, wherein the second GUI comprises graphical buttons.

11. The system of claim 8, wherein the second GUI comprises graphical elements that are selected by the consumer in order to input the first portion of the account identifier, and wherein the data indicative of the first portion of the account identifier comprises screen coordinates of the graphical elements selected by the consumer.

12. The system of claim 11, wherein the payment facilitator is configured to determine the first portion of the account identifier based on the screen coordinates.

13. A method for protecting account identifiers in financial transactions, comprising:
prompting, via a consumer computing apparatus, a consumer to input an account identifier uniquely identifying a financial account issued of a financial institution to be used in a financial transaction for purchasing a good or service from a merchant associated with a merchant computing apparatus;
transmitting data indicative of at least a first portion of the account identifier via a connection that bypasses the merchant computing apparatus;
receiving the data from the connection;
determining the account identifier based on the received data; and
transmitting a request for initiating payment from the financial account to be used in the financial transaction to a financial account of the merchant, wherein the request comprises the determined account identifier.

14. The method of claim 13, wherein the financial transaction is PIN-less.

15. The method of claim 13, further comprising:
receiving keyless user inputs for selecting graphical elements; and
defining the data indicative of the first portion of the account identifier based on the keyless user inputs.

16. The method of claim 15, further comprising:
receiving keyed user inputs;
defining data indicative of a second portion of the account identifier based on the keyed user inputs,
wherein the determining is based on the data indicative of the second portion of the account identifier.

17. The method of claim 13, further comprising transmitting data indicative of a second portion of the account identifier to the merchant computing apparatus, wherein the determining is based on the data indicative of the second portion of the account identifier.

18. The method of claim 13, further comprising:
transmitting logic from the merchant computing apparatus to the consumer computing apparatus;
executing the logic; and
displaying a first graphical user interface (GUI) via the consumer computing apparatus based on the executing, wherein the prompting is performed via the first GUI.

19. The method of claim 18, further comprising:
transmitting to the consumer computing apparatus via the connection data defining a second GUI; and
displaying the second GUI based on the data defining the second GUI,
wherein the prompting comprises prompting the consumer to input the first portion of the account identifier via the second GUI.

20. The method of claim 19, wherein the displaying the second GUI is performed in response to selection of a graphical element of the first GUI by the consumer.
